(19) United States
(12) Patent Application Publication
(10) Pub. No.: US 2009/0207725 A1
(43) Pub. Date: Aug. 20, 2009

(54) METHOD AND SYSTEM FOR JOINT ENCODING MULTIPLE INDEPENDENT INFORMATION MESSAGES

(76) Inventor: Wenfeng ZHANG, San Diego, CA (US)

Correspondence Address: MORRISON & FOERSTER LLP, 12531 HIGH BLUFF DRIVE, SUITE 100, SAN DIEGO, CA, 92130-2040, US

(21) Appl. No.: 12/368,922

(22) Filed: Feb. 10, 2009

Related U.S. Application Data
(60) Provisional application No. 61/027,772, filed on Feb. 11, 2008.
(60) Provisional application No. 61/038,001, filed on Mar. 19, 2008.
(60) Provisional application No. 61/040,607, filed on Mar. 28, 2008.

(51) Int. Cl. H04J 11/00

(52) U.S. Cl. 370/203

(57) ABSTRACT

A method and system for joint encoding multiple independent information messages are disclosed. In one embodiment, a system includes an encoder configured to encode each of the independent information messages to produce respective encoded bits, and a first multiplexer configured to multiplex each of the independent information messages. A joint block encoder encodes the multiplexed independent information messages to produce encoded common parity bits shared by all independent information messages, and a second multiplexer multiplexes the respective encoded bits from all independent channel encoders and the encoded common parity bits from the joint block encoder to produce the final output.

### CROSS-REFERENCE TO RELATED APPLICATIONS

This application claims priority to U.S. Provisional Patent Application No. 61/027,772 filed on Feb. 11, 2008, entitled “METHOD FOR JOINT ENCODING MULTIPLE INDEPENDENT INFORMATION MESSAGES”, U.S. Provisional Patent Application No. 61/038,001, filed Mar. 19, 2008, entitled “METHOD FOR JOINT TRANSMISSION AND RECEPTION OF MULTIPLE INFORMATION MESSAGES WITH UNEQUAL ERROR PROTECTION”, and U.S. Provisional Patent Application No. 61/040,607, filed Mar. 28, 2008, entitled “METHODS FOR JOINT TRANSMISSION AND RECEPTION OF ACK/NACK AND CQI IN LTE SYSTEM”, the contents of all of which are incorporated by reference herein in their entirety.

### FIELD OF THE INVENTION

The present invention relates generally to the transmission of multiple messages in a communication system, and more particularly to the transmission of multiple messages where the messages have no cross-information with each other, but are jointly channel coded before transmission.

### BACKGROUND

In order to enhance robustness against transmission error in communication systems, a forward error correction (FEC) mechanism, referred to as channel coding, is used at the transmission side. The coded symbols outputted from a channel coding device contain redundant symbols, which are called parity symbols, compared to the raw information that is input to the channel coding device. It is the coded symbols after the channel coding that are actually transmitted. On the receiver side, channel decoding is utilized to recover the original information message from the noise-corrupted coded symbols.

In communication systems, it is generally necessary to send multiple independent information messages simultaneously from one entity to another. In a normal situation, these independent information messages are channel coded and transmitted separately. However, in certain circumstances, some independent messages can contribute to a same set of parity symbols via a so-called “joint encoding” procedure. This joint encoding procedure can save the total number of parity symbols and meanwhile get each message error-protected from the shared set of parity symbols. In addition, it can also assign a different level of error correction capabilities to different messages, because each message can still have its own unique channel coding procedure, in addition to the “joint encoding” procedure.

A two-message joint coding architecture has previously been proposed as shown in FIG. 1. In this architecture, the two independent messages are represented by two vectors \vec{a} and \vec{b}. The lengths of the two messages are defined as the number of bits in each message, which are K₁ and K₂, respectively. The message \vec{a} is fed into the block encoder 102. The output sequence of encoder 102 is represented by vector \vec{u}, whose length is M₁. Similarly, the message \vec{b} is fed into the block encoder 104. The output sequence of encoder 104 is represented by vector \vec{v}, whose length is M₂. Generally speaking, K₁≦M₁ and K₂≦M₂. Vectors \vec{u} and \vec{v} are multiplexed together by MUX 106 to form a new sequence with length M₁+M₂. This new sequence is fed into the joint block encoder 108, to generate vector \vec{y}, the final output of the overall joint encoding architecture. The vector \vec{y} has length of N, where generally N≧M₁+M₂. In this two-stage concatenation architecture, there are encoding procedures in each stage, and the final output is a codeword of joint block encoder 108.

The above two-stage concatenation architecture for the joint encoding has some drawbacks. First, given the design parameters K₁, K₂, M₁, M₂ and N, the joint encoding architecture in FIG. 1 is limited in terms of the availability of most effective codebook for that joint encoding procedure. Secondly, the consideration for the optimal design of encoders 102 and 104 in the first stage interferes with that of encoder 108 in the second stage, which makes the optimal designs of these encoders not straightforward. Thirdly, the final output of the above architecture is the single codeword of encoder 108, which makes it difficult to differentiate the outputs corresponding to different raw information messages. Sometimes this differentiation is desired to allow different handlings in a post-stage, such as transmission with different powers or different modulation schemes.

### SUMMARY OF THE INVENTION

The presently disclosed embodiments are directed to solving one or more of the problems presented in the prior art, described above, as well as providing additional features that will become readily apparent by reference to the following detailed description when taken in conjunction with the accompanying drawings.

One embodiment is directed to a method for jointly encoding multiple independent information messages in a communication system. The method includes encoding each of the independent information messages to produce respective encoded bits, and multiplexing each of the independent information messages. The method further includes joint encoding the multiplexed independent information messages to produce encoded common parity bits shared by all independent information messages; and multiplexing the respective encoded bits from each of the independent informant messages and the encoded common parity bits.

Another embodiment is directed to a system for jointly encoding multiple independent information messages in a communication system. The system includes an encoder configured to encode each of the independent information messages to produce respective encoded bits; a first multiplexer configured to multiplex each of the independent information messages; a joint block encoder configured to encode the multiplexed independent information messages to produce encoded common parity bits shared by all independent information messages; and a second multiplexer configured to multiplex the respective encoded bits from each of the independent informant messages and the encoded common parity bits.

Yet another embodiment is directed to a computer-readable medium storing instructions thereon for performing a method of jointly encoding multiple independent information messages in a communication system. The method includes encoding each of the independent information messages to produce respective encoded bits; multiplexing each of the independent information messages; joint encoding the multiplexed independent information messages to produce encoded common parity bits shared by all independent information messages; and multiplexing the respective encoded bits from each of the independent informant messages and the encoded common parity bits.

Yet another embodiment is directed to a system for jointly encoding multiple independent information messages in a communication system. The system includes means for encoding each of the independent information messages to produce respective encoded bits; means for multiplexing each of the independent information messages; means for joint encoding the multiplexed independent information messages to produce encoded common parity bits shared by all independent information messages; and means for multiplexing the respective encoded bits from each of the independent informant messages and the encoded common parity bits.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following Figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is a prior art joint encoding architecture for two messages.

FIG. 2 is a joint encoding architecture for two messages, according to an embodiment.

FIG. 3 is a joint encoding architecture for L messages (L>1), according to an embodiment.

FIGS. 4(a) and 4(b) are two frame (or subframe) structures in an LTE system for a PUCCH channel that could carry both ACK/NACK and CQI information, according to an embodiment.

FIG. 5 shows a transmission procedure for a codeword-puncturing method that jointly transmits two messages, according to an embodiment.

FIG. 6 shows a transmission procedure for a codeword-extending method that jointly transmits two messages, according to an embodiment.

FIG. 7 shows a receiving procedure for a codeword-puncturing method that jointly transmits two messages, according to an embodiment.

FIG. 8 shows a receiving procedure for a codeword-extending method that jointly transmits two messages, according to an embodiment.

FIGS. 9(a) and 9(b) show scenarios in which joint encoding methods can coexist with individual transmissions of each message, according to an embodiment.

FIG. 10 is a flowchart illustrating a method for jointly encoding multiple independent information messages in a communication system, according to an embodiment.

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

The word “exemplary” is used herein to mean “serving as an example or illustration.” Any aspect or design described herein as “exemplary” is not necessarily to be construed as preferred or advantageous over other aspects or designs.

Reference will now be made in detail to aspects of the subject technology, examples of which are illustrated in the accompanying drawings, wherein like reference numerals refer to like elements throughout.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Embodiments disclosed herein describe a wireless cellular communication system where the transmission direction from a base station to mobile station is called downlink, while the opposite direction is called uplink. On both downlink and uplink, the radio signal transmissions over the time are divided into periodic frames (or subframes, slots, etc). Each radio frame contains multiple time symbols that include data symbols (DS) and reference symbols (RS). Data symbols carry the data information, while the reference symbols are known at both transmitter and receiver, and are used for channel estimation purposes. Note that Long Term Evolution (LTE) systems, for example, use “subframe” as the terminology to indicate a “frame”, according to certain embodiments. It is further noted that the functions described in the present disclosure may be performed by either a base station or a mobile station. A mobile station may be any user device such as a mobile phone. Alternately, a mobile station may be a personal digital assistant (PDA) such as a Blackberry device, MP3 player or other similar portable device. According to some embodiments, mobile station may be a personal wireless computer such as a wireless notebook computer, a wireless palmtop computer, or other mobile computer devices. A mobile station may also be referred to as user equipment (UE).

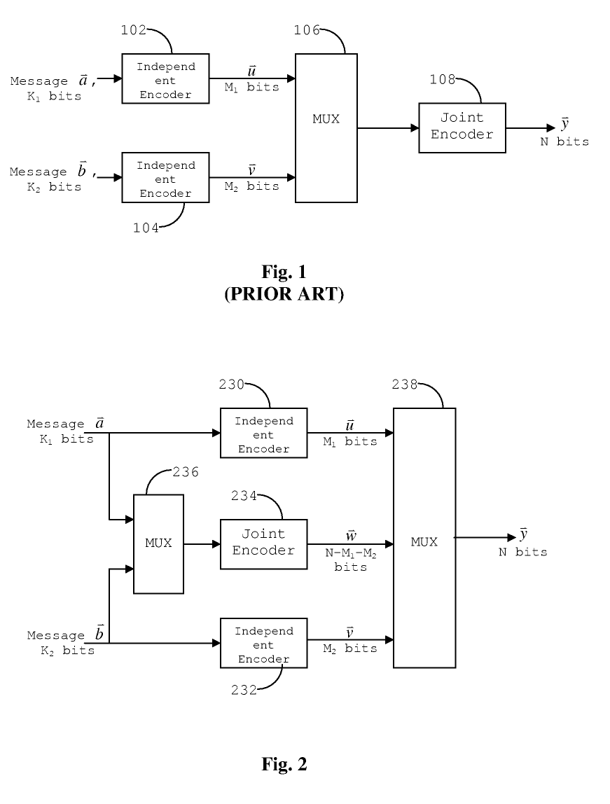

Encoding procedures can be mathematically represented by the input message vector as a row vector multiplied with the corresponding generator matrix. Referring to FIG. 1, for example, assume generator matrices for the encoder 102, encoder 104 and encoder 108 are G₁, G₂ and G₃, respectively. The dimension of matrix G₁ is K₁×M₁; the dimension of matrix G₂ is K₂×M₂; and the dimension of matrix G₃ is (M₁+M₂)×N. In addition, for the block codes, the generator matrix of the block code can always be equivalently rewritten in the systematic form of G=(I P), where I is an identity matrix. It may be further assumed that the matrix G₃ can be partitioned as

$${G}_{3} = ( {I}_{{M}_{1} + {M}_{2}} \vert \begin{matrix}{P}_{3 , 1} \\ {P}_{3 , 2}\end{matrix} ) ,$$

where the sub-matrix P_{3,1} has the dimension of M₁×(N−M₁−M₂) and the sub-matrix P_{3,2} has the dimension of M₂×(N−M₁−M₂).

With the above defined notations, the output vector \vec{y} can be mathematically calculated as:

$$\begin{matrix}\overline{y} = ( \begin{matrix}\overline{u} & \overline{v} ) \cdot {G}_{3}\end{matrix} \\ = ( \begin{matrix}\overline{a} \cdot {G}_{1} & \overline{b} \cdot {G}_{2} ) \cdot {G}_{3}\end{matrix} \\ = ( \begin{matrix}\overline{a} & \overline{b} ) \cdot \end{matrix} ( \begin{matrix}{G}_{1} & 0 \\ 0 & {G}_{2}\end{matrix} ) \cdot ( {I}_{{M}_{1} + {M}_{2}} \vert \begin{matrix}{P}_{3 , 1} \\ {P}_{3 , 2}\end{matrix} ) \\ = ( \begin{matrix}\overline{a} & \overline{b} ) \cdot \end{matrix} ( \begin{matrix}{G}_{1} & 0 & {G}_{1} \cdot {P}_{3 , 1} \\ 0 & {G}_{2} & {G}_{2} \cdot {P}_{3 , 2}\end{matrix} )\end{matrix}$$

Here the addition is in modulo based on the alphabetic size. So the effective codebook is constructed by the generator matrix of

$$( \begin{matrix}{G}_{1} & 0 & {G}_{1} \cdot {P}_{3 , 1} \\ 0 & {G}_{2} & {G}_{2} \cdot {P}_{3 , 2}\end{matrix} ) .$$

It can be seen that, this generator matrix constructs a strict sub-set of an alternative matrix, which is

$$( \begin{matrix}\begin{matrix}{G}_{1} & 0 \\ 0 & {G}_{2}\end{matrix} & P\end{matrix} ) .$$

The rational relies in the fact that, given G₁ and G₂, one can always derive P from P_{3,1} and P_{3,2}, but not necessarily P_{3,1} and P_{3,2} from P. This characteristic indicates the generator matrix

$$( \begin{matrix}\begin{matrix}{G}_{1} & 0 \\ 0 & {G}_{2}\end{matrix} & P\end{matrix} )$$

allows more possibilities for a codebook construction, which may lead to a better codebook that the generator matrix

$$( \begin{matrix}{G}_{1} & 0 & {G}_{1} \cdot {P}_{3 , 1} \\ 0 & {G}_{2} & {G}_{2} \cdot {P}_{3 , 2}\end{matrix} )$$

can not give. Assume d_{old} is the minimum hamming distance for generator matrix

$$( \begin{matrix}{G}_{1} \cdot {P}_{3 , 1} \\ {G}_{2} \cdot {P}_{3 , 2}\end{matrix} ) ,$$

and d_{new} is the minimum hamming distance for generator matrix P, whose dimension is (K₁+K₂)×(N−M₁−M₂). From coding theory perspective, the code words in

$$( \begin{matrix}{G}_{1} \cdot {P}_{3 , 1} \\ {G}_{2} \cdot {P}_{3 , 2}\end{matrix} )$$

are the linear combination of rows in

$$( \begin{matrix}{P}_{3 , 1} \\ {P}_{3 , 2}\end{matrix} ) ,$$

whose dimension is (M₁+M₂)×(N−M₁−M₂). Because of the fact that (K₁+K₂)≦(M₁+M₂), it generally holds that d_{old}≦d_{new}.

The three block columns in matrix

$$( \begin{matrix}\begin{matrix}{G}_{1} & 0 \\ 0 & {G}_{2}\end{matrix} & P\end{matrix} )$$

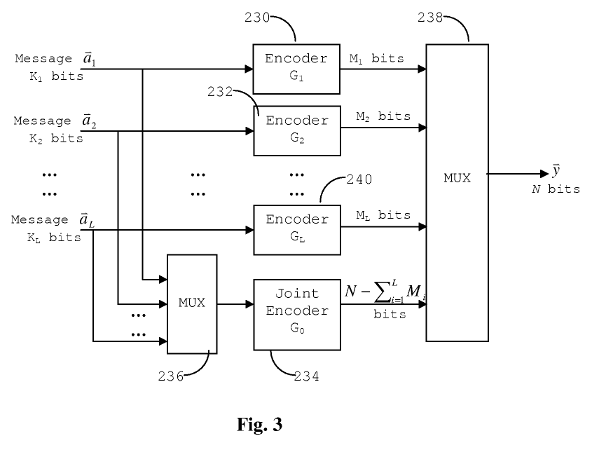

indicate the three components in the final codeword, which lead to the joint encoding architecture shown in FIG. 2.

FIG. 2 is joint encoding architecture for two messages, according to one embodiment. FIG. 2 shows the individual encoding output from encoder 230 with generator matrix G₁, the individual encoding output from encoder 232 with generator matrix G₂, and the parity symbols from joint encoder 234 with generator matrix P. The input to the joint encoder 234 is the multiplex of two information messages via MUX 236. The final output \vec{y} is the multiplex of outputs from three encoders via MUX 238.

According to one embodiment, as compared to conventional architectures, the joint encoding architecture of FIG. 2 for the two independent messages minimizes the number of rows in the joint encoder generator matrix P, because doing so can maximize the minimum hamming distance inside the joint encoder generator matrix P. Meanwhile, the number of rows in the joint encoder generator matrix P can not be smaller than the total number of information bits in the two involved messages, which is (K₁+K₂).

This principle can be applied to the system with more than two independent messages. FIG. 3 shows the architecture for joint encoding of L independent messages, where L can be any integer that is larger than 1, according to one embodiment. As shown in FIG. 3, the information bits of the i-th (1≦i≦L) message are fed into independent block encoder Gᵢ (230, 232 . . . 240). Meanwhile they are also fed into the joint encoder G₀ 234, after multiplexed with the information bits from other messages. The outputs from all independent encoders and the joint encoders are multiplexed together as the final encoding output \vec{y}. The overall generator matrix for this joint encoding architecture may be expressed by:

$$( \begin{matrix}{G}_{1} & 0 & … & 0 \\ 0 & {G}_{2} & & ⋮ \\ ⋮ & & ⋱ & 0 \\ 0 & … & 0 & {G}_{L}\end{matrix} \vert {G}_{0} )$$

where matrix Gᵢ has dimension Kᵢ×Mᵢ for 1≦i≦L, and matrix G₀ has dimension

$$( {\sum }_{i = 1}^{L} {K}_{i} ) \times ( N - {\sum }_{i = 1}^{L} {M}_{i} ) .$$

It is noted that G₀ is also denoted as G_{J} in certain provisional patent applications incorporated herein by reference. It can be seen that the matrix P in the previous discussion is one form of G₀ when L=2. Because the matrix G₀ serves as the generation of the parity bits, it can be obtained from a mother block code (n,k) with

$$k = {\sum }_{i = 1}^{L} {K}_{i} and n = N - {\sum }_{i = 1}^{L} ( {M}_{i} - {K}_{i} ) \cdot$$

This mother block code may have generator matrix such as (I G₀), where I is the identity matrix in

$$k = {\sum }_{i = 1}^{L} {K}_{i}$$

dimensions.

One general architecture is described herein with reference to FIG. 3. However, there maybe several variations based upon the principles mentioned according to embodiments of this invention. For example, according to one embodiment, the different partitions of joint encoding generator matrix G₀ may result in architecture charts different from what is given in FIG. 3. Similarly, according to another embodiment, the independent encoder 232-240 can have an identity matrix I as the generator matrix Gᵢ (i=1 . . . L) that means the i-th message is directly passed to the joint encoder 234 without individual encoding, or it can be a tail-biting convolution encoder whose operation is always equivalent to block encoding, or it can correspond to Gᵢ=0 (i=1 . . . L) that is also equivalent to removing all output symbols of encoder Gᵢ from the final stage multiplexer 238. As long as the varied joint encoding matrix is equivalent to or is a special case of G₀ mentioned above, and/or the varied independent encoding matrix is equivalent to or is a special case of Gᵢ mentioned above, the varied architecture is equivalent to the joint encoding architecture described herein.

Embodiments of the present invention may be implemented when two or more of the messages have different requirements on the error rate target, for example. In particular, embodiments disclosed herein have specific application but not limited to the Long Term Evolution (LTE) system that is one of the candidates for the 4-th generation wireless system.

In LTE system, for example, there may be two uplink controlling messages that are needed to transmit from the mobile station to the base station. One of them is called ACK/NACK signaling, which serves as the acknowledgement to the downlink HARQ transmission. One bit ACK/NACK corresponds to one downlink Hybrid Automatic Repeat-Request (HARQ) channel to indicate whether the latest packet on that downlink HARQ channel is successfully received or not. An ACK is sent upon successful reception of downlink HARQ packet, otherwise NACK is sent. There can be either one bit (N_{ACK}=1) or two bits (N_{ACK}=2) ACK/NACK per ACK/NACK message in LTE system. Sometimes, due to loss of the downlink grant message, the mobile station fails to know there is a downlink HARQ transmission for it and therefore does not attempt to transmit an ACK/NACK at all. This is called an ACK discontinuous transmission (DTX) on the uplink. The base station may avoid detecting ACK from DTX.

The second message is called a channel quality indication (CQI) message, which is the feedback to tell the base station about the downlink channel quality measured at the mobile station. The number of bits per CQI message (N_{CQI}) varies per message-basis. To maintain the sufficient channel coding gains while keeping the same channel coding implementation hardware when N_{CQI} varies, the (20, A) Reed-Muller block code, for example, is used to transmit a CQI-alone message, with A reflecting the changes of number of input bits. The ACK/NACK signaling may have strict error rate requirement with bit error rate (BER) usually lower than 0.1%, while the block error rate (BLER) of CQI message may be required to be lower than 1%. There are occasions that these two messages are transmitted at the same time within the limited radio link resources. The physical wireless channel used to send these two uplink controlling messages in LTE is called Physical Uplink Control Channel (PUCCH). By utilizing the general joint transmission architecture in this invention, the transmission resources including bandwidth and power are saved, and the different error rate requirements on different messages are maintained.

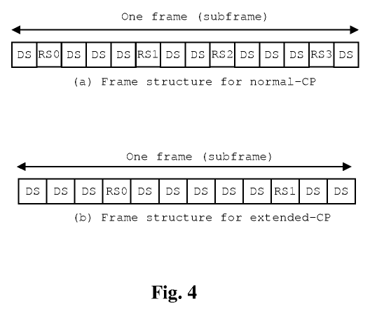

There are two frame structures in LTE systems. One is called a frame with normal cyclic prefix (normal-CP), another is called a frame with extended cyclic prefix (extended-CP). The PUCCH carrying CQI in the normal-CP frame has 10 QPSK-modulated data symbols and 4 reference symbols, as shown in FIG. 4(a). The PUCCH carrying CQI in the extended-CP frame has 10 QPSK-modulated data symbols and 2 reference symbols, as shown in FIG. 4(b). The channel coding for CQI-only transmission is the (20,A<15) code that is punctured or extended from regular Reed-Muller codes, for example. The common generator matrix for this (20,A) code is a 14-by-20 binary matrix and is given below:

1,1,1,1,1,1,1,1,1,1,1,1,1,1,1,1,1,1,1,1,

1,1,0,0,1,1,0,0,1,0,0,1,0,1,0,1,1,0,1,0,

0,1,0,1,1,0,1,0,0,1,1,1,0,0,0,0,1,0,0,0,

0,0,1,1,1,0,0,1,1,1,0,0,1,1,0,0,0,1,1,0,

0,0,0,0,0,1,1,1,1,1,0,0,0,0,1,1,1,1,1,0,

0,0,0,0,0,0,0,0,0,0,1,1,1,1,1,1,1,1,1,1,

0,0,1,0,0,1,1,0,0,1,1,1,0,0,0,1,1,0,1,1,

0,0,0,0,1,1,0,1,1,0,1,0,1,1,1,1,0,0,1,0,

0,0,1,1,0,1,1,1,0,0,0,1,1,0,0,0,0,1,0,0,

0,1,1,0,0,0,1,0,1,1,1,0,1,1,0,1,1,0,0,0,

1,1,1,1,1,1,1,1,1,1,1,1,1,1,1,1,0,0,0,0,

1,1,1,1,1,1,1,1,1,1,1,1,1,1,0,0,1,1,0,0,

0,0,1,1,1,1,1,1,1,1,1,1,1,1,1,1,1,1,0,0,

0,0,1,1,1,0,0,1,1,1,1,1,1,1,1,1,1,1,1,1

Besides the CQI-only transmission, the simultaneous transmission of ACK/NACK and CQI may be necessary and occasionally happens for these two PUCCH in both the normal-CP frame and the extended-CP frame.

The error protection capability for each message is guarded by the minimum hamming weight of the error codeword vector (non-zero vector) for that message, and therefore is lower-bounded by dₘᵢₙ(Gᵢ)+dₘᵢₙ(G₀) (i=1 . . . L ) for message i, where dₘᵢₙ(G) is the minimum hamming distance of the code space spanned by generator matrix G. It can be seen that, compared to individual encoding with Gᵢ, the error protection capability for each message is enhanced by dₘᵢₙ(G₀) that consumes only shared resources. In addition, the unequal error protection can be realized by differentiating dₘᵢₙ(Gᵢ) (i=1 . . . L) for all messages. When L=2, the overall generator matrix is given by:

$$( \begin{matrix}{G}_{1} & 0 \\ 0 & {G}_{2}\end{matrix} \vert {G}_{0} )$$

For exemplary purposes the following embodiment assumes the joint transmission of two messages, i.e., L=2, and an LTE system as the application environment, i.e., K₁ and K₂ are chosen from N_{ACK} and N_{CQI}. However, the present invention can be applied to situation with L>2 as well as other wireless communication systems. It is further noted that the joint encoding can be performed over various types of information, other than ACK/NACK or CQI.

As mentioned above, in an LTE system, it is beneficial to perform the joint encoding and transmission of ACK/NACK and CQI messages if their transmissions occur on PUCCH in the same frame. It is noted that, the PUCCH has 10 QPSK-modulated data symbols in both the normal-CP frame and the extended-CP frame, and the normal-CP frame has two more reference symbols than the extended-CP frame. This means PUCCH can at least hold N=20 binary coded data symbols per frame. Embodiments disclosed herein assume, for exemplary purposes, that two reference symbols per PUCCH frame are the minimum to guarantee the channel estimation performance, as they have to be for the extended-CP frame. Therefore, it is possible to replace one or two reference symbols in the normal-CP frame with complex data symbols to increase the channel coding gain of PUCCH.

According to various embodiments, there may be two methods, namely codeword-puncturing method and codeword-extending method, to jointly encode and transmit the ACK/NACK and CQI messages. Both methods make the following assumptions, for exemplary purposes:

There may be no significant difference between detecting ACK DTX and explicitly receiving N_{ACK} NACK's at a base station, in other words, Prob{NACK|DTX}, Prob{DTX|NACK} and Prob{DTX|ACK} are not the concern;

NACK is represented by binary “0”, while ACK is represented by “1”;

A mobile station either successfully decodes the downlink grant or completely failed to do so, which means it is more likely for the mobile station to miss the grant than to misinterpret the grant such as mistaking N_{ACK}=1 and N_{ACK}=2 for each other; and

The values of N_{ACK} and N_{CQI} used in each joint transmission are known at the base station and the mobile station. Of course various other assumptions may be made without departing from the scope of the invention.

### Transmitter and Receiver for Codeword-Puncturing Method

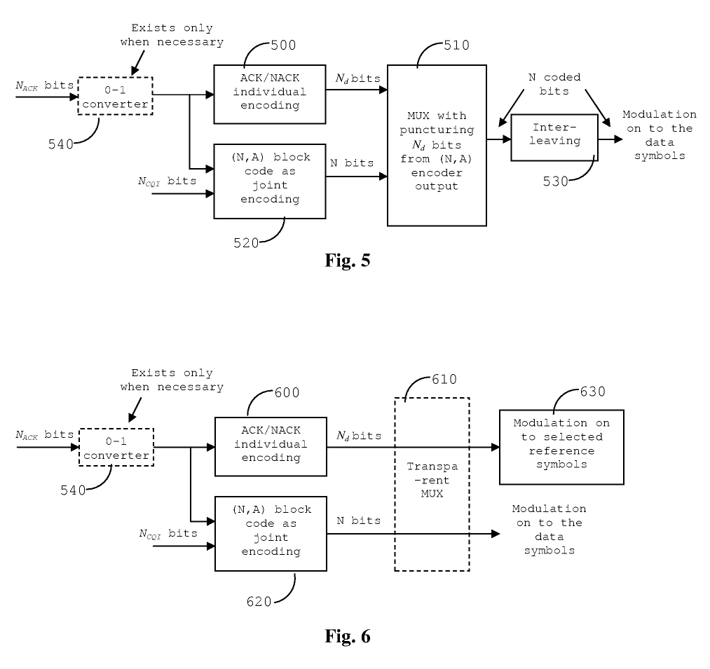

The transmission procedure of codeword-puncturing method is shown in FIG. 5, in accordance with one embodiment. As shown in FIG. 5, the ACK/NACK individual encoding 500 takes N_{ACK} input bits and outputs N_{d} coded bits. The code design should be such that the minimum hamming distance of this (N_{d},N_{ACK}) code is maximized. To qualify this criteria, the simple repetition code, whose generator matrix is

$$( \underbrace{1 … 1}_{{N}_{d}} ) ,$$

shall be used when N_{ACK}=1, and the cyclic simplex code, whose systematic generator matrix for one cycle is

$$( \begin{matrix}1 & 0 & 1 \\ 0 & 1 & 1\end{matrix} ) ,$$

shall be used when N_{ACK}=2.

For the bit ordering of input to (N,A) block coding 520, ACK bits always follow the CQI bits, that is, if the input bits to (N,A) coding are defined as a₀, a₁, a₂, a₃, . . . , a_{A-1}, ACK/NACK and CQI bits shall be multiplexed in such a way that

$${a}_{i} = \{ \begin{matrix}CQI bit & 0 \leq i < {N}_{CQI} \\ ACK bit & {N}_{CQI} \leq i < A\end{matrix}$$

The MUX unit 510 inserts the N_{d} coded bits from ACK/NACK individual encoder 500 to the specific N_{d} positions that are marked as punctured inside (N,A) encoder 520 output, and leaves other non-punctured coded bits unchanged. Theoretically, N_{d} shall satisfy the inequality of N_{ACK}+N_{CQI}≦N−N_{d}. In order to make the base station and mobile sync-up with the same value of N_{d}, either the explicit signaling exchange is used, or the derivation function on other parameters is specified, for example, N_{d} can be a function of <N_{ACK},N_{CQI}>. In the design for LTE systems, N_{d} can be chosen from {1, 2, 3, 4}. The puncturing patterns on the (N,A) encoder 520 output shall maintain the minimum hamming distance of code space spanned by

$$( \begin{matrix}{P}_{11} \\ {P}_{12}\end{matrix} )$$

as maximum as possible for all applicable values of A. For the (N=20,A) code specified in LTE systems, exemplary puncturing patterns are given in Table 1, where the coded bits indices are defined in the LTE specification. The 14-by-20 binary matrix above also shows the coded bit index counting the most-left column as index 0.

TABLE 1
Puncturing pattern in code-puncturing method

| N_{d} | Indices of punctured coded bits |
|---|---|
| 1 | 7 |
| 2 | 7, 18 |
| 3 | 12, 15, 18 |
| 4 | 12, 15, 17, 18 |

The interleaving unit 530 in FIG. 5 serves to evenly distribute the puncturing positions within the frame. The interleaving pattern is not specified in this disclosure, because one of ordinary skill in the art would realize that it can be implemented in many different ways. In fact, this interleaving unit can be removed if its functionality is implemented into (N,A) codes by exchanging the columns of the generator matrix (if so, the puncturing pattern needs the same change). If an interleaving function is applied to the joint encoding 520 of ACK/NACK and CQI, no matter how it is implemented, the same interleaving pattern shall be applied to the CQI-only transmission, according to one embodiment.

The N bits from the MUX unit 510 are modulated on to the available data symbols. QPSK may be used in LTE systems, while alternative modulation schemes may be useable as well. For the codeword-puncturing method, the reference symbols do not carry data information and are fully available to channel estimation at the receiver. For LTE systems, the codeword-puncturing method can be applied to either the normal-CP PUCCH or the extended-CP PUCCH shown in FIG. 4.

It can be seen that the generator matrix of codeword-puncturing method can be written as

$$( \begin{matrix}{P}_{11} & 0 \\ {P}_{21} & {G}_{ACK}\end{matrix} ) , where ( \begin{matrix}{P}_{11} \\ {P}_{12}\end{matrix} )$$

comes from the generator matrix of the (N,A) code and corresponds to the non-punctured symbols of N output coded symbols, while G_{ACK} is the generator matrix for the ACK/NACK individual encoder 500 according to one embodiment. This effective generator matrix is equivalent to setting

$${G}_{0} = ( \begin{matrix}{P}_{11} \\ {P}_{12}\end{matrix} ) , {G}_{2} = {G}_{ACK}$$

and G₁=0. Therefore this codeword-puncturing method may be implemented in the case of the general joint encoding architecture in FIG. 2, for example.

For a PUCCH supposed to contain both ACK/NACK and CQI information, the base station knows that the mobile station either performs joint encoding of ACK/NACK and CQI, or transmits only CQI information bits with (N,A=N_{CQI}) codes due to a loss of a downlink grant message. The receiver may have two options: one without DTX handling, where the base station only needs to detect two states, ACK and NACK, from the received PUCCH and relies on lowering downlink grant missing probability to protect against the downlink packet loss due to detection of ACK from DTX; and another with DTX handling which means the base station needs to detect three states of {ACK, NACK, DTX} for ACK/NACK transmission.

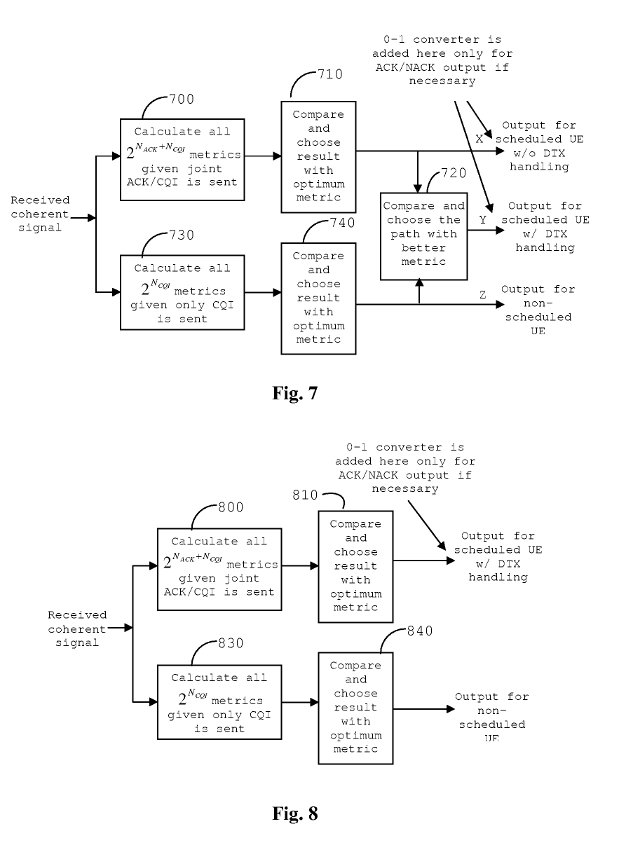

One of the possible receiver structures for the codeword-puncturing method is given in FIG. 7, according to one embodiment. This receiver structure is optimal in terms of maximum likelihood. According to FIG. 7, if the base station previously sends a downlink grant to the mobile station and assumes that the mobile station will send both ACK/NACK and CQI on the PUCCH at operation 700, output X is chosen if the receiver does not handle DTX (as determined at operation 710) or output Y if otherwise (as determined at operation 720).

On the other hand, if the base station knows that the mobile station does not have a downlink grant and therefore has no ACK/NACK to transmit on PUCCH at operation 730, only the lower path with output Z is utilized (as determined at operation 740).

### Transmitter and Receiver for Codeword-Extending Method

The codeword-extending method, according to one embodiment, is shown in FIG. 6. The ACK/NACK individual encoding 600 is the same as the one for codeword-puncturing method described above with respect to reference number 500. It takes N_{ACK} input bits and outputs N_{d} coded bits. The code design should be such that the minimum hamming distance of this (N_{d},N_{ACK}) code is maximized. To qualify this criteria, the simple repetition code, whose generator matrix is

$$( \underbrace{1 … 1}_{{N}_{d}} ) ,$$

shall be used when N_{ACK}=1, and the cyclic simplex code, whose systematic generator matrix for one cycle is

$$( \begin{matrix}1 & 0 & 1 \\ 0 & 1 & 1\end{matrix} ) ,$$

shall be used when N_{ACK}=2.

For the bit ordering of input to (N,A) block coding 620, ACK bits always follow the CQI bits, that is, if the input bits to (N,A) coding are defined as a₀, a₁, a₂, a₃, . . . , a_{A-1}, ACK/NACK and CQI bits shall be multiplexed in such a way that

$${a}_{i} = \{ \begin{matrix}CQI bit & 0 \leq i < {N}_{CQI} \\ ACK bit & {N}_{CQI} \leq i < A\end{matrix}$$

The N-bit output from (N,A) encoder is modulated on to the available data symbols. QPSK may be used in LTE systems; however, one skilled in the art would realize that alternative modulation schemes may implemented.

The N_{d} output bits from the ACK/NACK individual encoder 600 are modulated on to the reference symbols. The modulation scheme depends on the value of N_{d}, which is generally limited by the number of available reference symbols. For LTE systems, N_{d} can be chosen from {1, 2, 3, 4}. Assume the ACK/NACK individual encoder 600 output is denoted as a′₀, a′₁, . . . , a′_{N}_{_{d}}₋₁, then the modulation and multiplexing on PUCCH reference symbols are specified by Table 2, where RSi (0≦i≦3) are i-th reference symbol per frame as defined in 4. It should be pointed out that other methods to multiplex individual ACK/NACK encoder outputs on to reference symbols may be utilized without departing from the scope of the present invention. For example, in OFDM systems, only certain subcarrier tones within reference symbols may be used for such multiplexing, and other subcarrier tones within reference symbols are available for channel estimation purposes.

TABLE 2
Modulation and multiplexing of
coded ACK/NACK bits on PUCCH RS

| | Modulated N_{d} | Modulation and multiplexing on |
|---|---|---|
| N_{d} | bits | {RS0, RS1, RS2, RS3} |
| 1 | a′₀ | BPSK on one RS, e.g., BPSK on RS1 |
| 2 | a′₀, a′₁ | QPSK on one RS, e.g., QPSK on RS1, or |
| | | BPSK on two RS, e.g., BPSK on {RS1, RS3} |
| 3 | a′₀, a′₁, a′₂ | QPSK on one RS, BPSK on another RS, e.g., |
| | | a′₀, a′₁ on RS1 w/QPSK, a′₂ on RS3 w/BPSK |
| 4 | a′₀, a′₁, a′₂, a′₃ | QPSK on two RS, e.g., a′₀, a′₁ on |
| | | RS1 w/QPSK and a′₂, a′₃ |
| | | on RS3 w/QPSK |

Based upon this principle and the PUCCH reference symbol modulation constellation in the current LTE standard, the modulation scheme to modulate extended bits on the PUCCH reference symbols is given in Table for BPSK and Table for QPSK.

TABLE 3
BPSK modulation mapping for extended bit on PUCCH RS

| modulated | | |
|---|---|---|
| bit | I | Q |
| 0 | 1 | 0 |
| 1 | −1 | 0 |

TABLE 4
QPSK modulation mapping for extended bits on PUCCH RS

| modulated | | |
|---|---|---|
| bits | I | Q |
| 00 | 1 | 0 |
| 01 | 0 | −j |
| 10 | 0 | j |
| 11 | −1 | 0 |

It can be seen that the generator matrix of codeword-extending method can be written as

$$( \begin{matrix}{P}_{1} & 0 \\ {P}_{2} & {G}_{ACK}\end{matrix} ) , where ( \begin{matrix}{P}_{1} \\ {P}_{2}\end{matrix} )$$

is the generator matrix of (N,A) code and G_{ACK} is the generator matrix for ACK/NACK individual encoder 600. This effective generator matrix is equivalent to setting

$${G}_{0} = ( \begin{matrix}{P}_{1} \\ {P}_{2}\end{matrix} ) , {G}_{2} = {G}_{ACK}$$

and G₁=0. Therefore this codeword-extending method is an example of the special case of the general joint encoding architecture in FIG. 2, for example.

For a PUCCH supposed to contain both ACK/NACK and CQI information, the base station knows that the mobile station either performs joint encoding of ACK/NACK and CQI at encoder 620, or transmits only CQI information bits with (N,A=N_{CQI}) codes due to a loss of downlink grant message. Because the generator matrices used by the mobile station to send CQI-only PUCCH and the joint CQI+NACK PUCCH are the same (both equal to P₁) according to this exemplary embodiment, the base station only needs to detect two states, ACK and NACK, for the codeword-extending method.

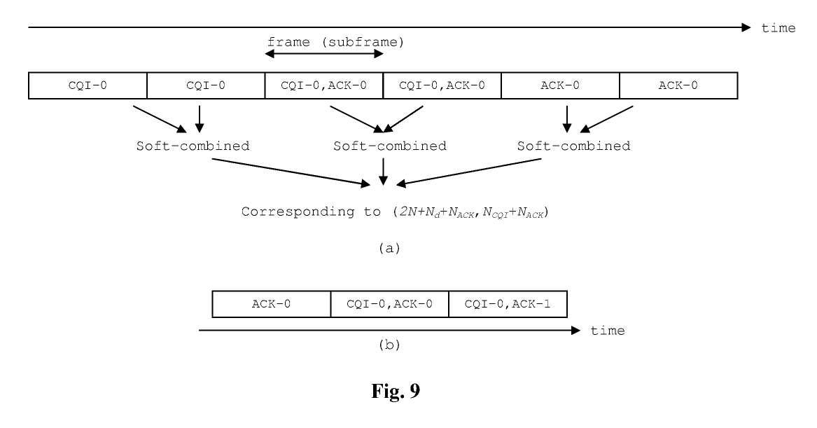

One possible receiver structure for the codeword-extending method is given in 8. This receiver structure is optimal in terms of maximum likelihood. As shown in FIG. 8, if the base station previously sends a downlink grant to the mobile station and assumes that the mobile station will sends both ACK/NACK and CQI on the PUCCH (determined at operation 800), then the results with the optimum metric will be chosen at operation 810 and the upper half path is utilized (i.e., output for scheduled user equipment (UE) with DTX handling). If the base station knows that the mobile station does not have a downlink grant and therefore has no ACK/NACK to transmit with CQI on PUCCH (determined at operation 830), then the results with the optimum metric will be chosen at operation 840 and only the lower path is utilized (i.e., output for non-scheduled UE).

### Coexistence of Joint-Encoding and Individual Transmission

In accordance with one embodiment, it is possible that two messages, A and C, are jointly encoded within a certain frame but are individually transmitted in other frames. Or, the transmissions of two messages either start from or end in different frames, with the joint encoding occurring only within those overlapped frames. It should be noted that the two joint encoding methods described above can still work when such joint encoding and individual transmission coexist, as long as message A is not jointly encoded with message C in different message contents, and vice versa.

This condition is depicted in FIGS. 9(a) and 9(b) for LTE systems, for example. For the exemplary transmission pattern in FIG. 9 (a), all jointly encoded PUCCHs are soft-combined; all individual CQI-only signals are soft-combined; all individual ACK-only signals are soft-combined. These three combined signals together can be mapped to a new block code (2N+N_{ACK}, N_{CQI}+N_{ACK}), whose generator matrix is

$$( \begin{matrix}{P}_{11} & {P}_{12} & {P}_{11} & 0 & 0 \\ 0 & 0 & {P}_{21} & {G}_{ACK} & {I}_{{N}_{ACK}}\end{matrix} )$$

for the codeword-puncturing method, or a new block code (2N+N_{d}+N_{ACK}, N_{CQI}+N_{ACK}), whose generator matrix is

$$( \begin{matrix}{P}_{1} & {P}_{1} & 0 & 0 \\ 0 & {P}_{2} & {G}_{ACK} & {I}_{{N}_{ACK}}\end{matrix} )$$

for the codeword-extending method. It can be seen that both equivalent generator matrices may be used in the general joint encoding architecture in FIG. 2, for example

In FIG. 9(b), the overlapped joint encoded PUCCH corresponds to different ACK bits, which prevents the direct soft-combining and makes the joint decoding difficult, though the sub-optimal decoding method is still available. Fortunately, such a transmission pattern as in FIG. 9 (b) can be avoided because all transmissions of ACK/NACK and CQI as well as the CQI report cycle can be controlled by a scheduling algorithm in the base station, for example.

According to one or more embodiments, various assumptions above may not hold in an LTE system. That is, for example, NACK may be encoded by binary “1” and ACK may be encoded by binary “0”. Therefore a logic 0-1 converter 540 (see FIG. 5, for example) may be added to flip the ACK/NACK information bits at both input port of the transmitter (i.e., input to individual encoder 500) and at the receiver.

If a logic 0-1 converter is used on the transmission side (e.g., at a base station on the downlink transmission), according to one embodiment, a receiver structure, as shown in the codeword puncturing method of FIG. 7, for example, ACK/NACK output bits shall pass through a logic 0-1 converter on the receiver side (e.g., a mobile station on the downlink transmission). As shown in the codeword extending method of FIG. 8, ACK/NACK output bits shall may through a logic 0-1 converter if a logic 0-1 converter is used for ACK/NACK bits at the input port on transmitter side.

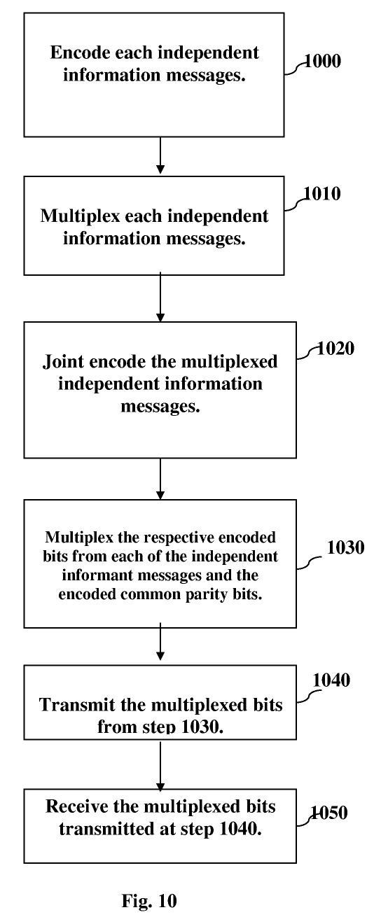

FIG. 10 is a flowchart illustrating a method for jointly encoding multiple independent information messages in a communication system, according to an embodiment. Referring to FIG. 10, at operation 1000 each of the independent information messages is encoded, by independent encoders 230-240, for example, to produce respective encoded bits. From operation 1000, the process continues to operation 1010 where each of the independent information messages are multiplexed together, at multiplexer 236, for example.

From operation 1010, the process continues to operation 1020 where the multiplexed independent information messages are joint encoded, at joint block encoder 234, for example, to produce encoded common parity bits shared by all independent information messages. From oration 1020, the process continues to operation 1030 where the respective encoded bits from each of the independent informant messages and the encoded common parity bits are multiplexed together, at multiplexer 238, for example.

The output of multiplexer 238, for example, may be transmitted from a base station to a mobile station in a downlink transmission, for example, or from a mobile station to a base station in an uplink transmission. A coherent signal is received by a receiver (e.g., a mobile station in a downlink transmission), where the original message is constructed.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the invention.

In this document, the terms “computer program product”, “computer-readable medium”, and the like, may be used generally to refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), when executed, enable the computing system.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization.

Furthermore, although individually listed, a plurality of means, elements or method steps may be implemented by, for example, a single unit or processing logic element. Additionally, although individual features may be included in different claims, these may possibly be advantageously combined. The inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for jointly encoding multiple independent information messages in a communication system, comprising:
encoding each of the independent information messages to produce respective encoded bits;
multiplexing each of the independent information messages;
joint encoding the multiplexed independent information messages to produce encoded common parity bits shared by all independent information messages; and
multiplexing the respective encoded bits from each of the independent informant messages and the encoded common parity bits.

2. The method of claim 1, wherein the joint encoding comprises generating a matrix G₀ in dimension
$$( {\sum }_{i = 1}^{L} {K}_{i} ) \times ( N - {\sum }_{i = 1}^{L} {M}_{i} ) ,$$
where L is a total number of independent information messages, N is a total length of a final output codeword, Kᵢ is a length of i-th information message and Mᵢ is an output length for the i-th encoded independent information message.

3. The method of claim 2, wherein an output of the joint encoding is express by \vec{x} G₀, where \vec{x} is a row vector of length
$${\sum }_{i = 1}^{L} {K}_{i}$$
and is obtained by multiplexing all independent information message bits, and the matrix G₀ is realized using a tentative block code
$$( n = N - {\sum }_{i = 1}^{L} ( {M}_{i} - {K}_{i} ) , k = {\sum }_{i = 1}^{L} {K}_{i} )$$
that has a systematic generator matrix obtained from a lookup table.

4. The method of claim 1, further comprising:
individually encoding one or more independent information messages depending on a required error protection of the one or more independent information messages.

5. The method of claim 4, wherein an error protection capability for each of the one or more independent information messages is lower-bounded by dₘᵢₙ(Gᵢ)+dₘᵢₙ(G₀) (i=1 . . . L) for message i, where dₘᵢₙ(Gᵢ) is a minimum hamming distance of code space spanned by a generator matrix Gᵢ, L is the number of the one or more independent information messages, and G₀ is a joint encoder generator matrix.

6. The method of claim 5, wherein the error protection for each of the one or more independent information messages is realized by differentiating dₘᵢₙ(Gᵢ) (i=1 . . . L) for each of the one or more independent information messages i.

7. The method of claim 6, wherein when L=2, the generator matrix G is represented by
$$\begin{matrix}( \begin{matrix}{G}_{1} & 0 \\ 0 & {G}_{2}\end{matrix} \vert & {G}_{0}\end{matrix} ) .$$

8. The method of claim 4, wherein the multiplexing the respective encoded bits from all independent channel encoders and the encoded common parity bits comprises further multiplexing coded bits from the joint encoding that have been punctured, wherein the number of punctured bits is not large enough to make an effective generator matrix singular for each independent information message.

9. The method of claim 8, further comprising:
interleaving the multiplexed coded bits such that punctured positions are evenly distributed within a frame.

10. The method of claim 9, wherein the interleaving comprises:
shuffling columns of the generator matrix of original code before further multiplexing coded bits from the joint encoding that have been punctured.

11. The method of claim 4, wherein the individually encoding comprises:
individual encoding N_{ACK} bits of ACK/NACK information, wherein a repetition code, whose generator matrix is
$$( \underbrace{1 … 1}_{all 1 ' s} ) ,$$
shall be used when N_{ACK}=1, and a cyclic simplex code, whose systematic generator matrix for one cycle is
$$( \begin{matrix}1 & 0 & 1 \\ 0 & 1 & 1\end{matrix} ) ,$$
shall be used when N_{ACK}=2.

12. The method of claim 11, wherein ACK is represented by logic 1, and NACK is represented by logic 0, and the ACK/NACK bits follow the CQI bits in a bit ordering of input to the joint encoding, such that if the input bits the joint encoding are defined as a₀, a₁, a₂, a₃, . . . , a_{A-1} the ACK/NACK and CQI bits are multiplexed before the joint encoding in such a way that
$${a}_{i} = \{ \begin{matrix}CQI bit & 0 \leq i < {N}_{CQI} \\ ACK bit & {N}_{CQI} \leq i < A .\end{matrix}$$

13. The method of claim 4, wherein the output coded bits from the joint encoding are modulated onto available data symbols, while the output coded bits from the individually encoding are modulated onto either available data symbols or non-data symbols.

14. The method of claim 10, further comprising:
receiving the multiplexed encoded bits without ACK DTX handling to decode a joint ACK/NACK and CQI transmission.

15. The method of claim 10, further comprising:
receiving the multiplexed encoded bits with ACK DTX handling to decode a joint ACK/NACK and CQI transmission.

16. The method of claim 10, further comprising:
receiving the multiplexed encoded bits to decode CQI bits only.

17. The method of claim 13, further comprising:
receiving the multiplexed encoded bits with ACK DTX handling by default to decode joint ACK/NACK and CQI transmission.

18. The method of claim 13, further comprising:
receiving the multiplexed encoded bits to decode CQI bits only.

19. The method of claim 10, further comprising:
logically converting the ACK/NACK information before the individually encoding, if the ACK is initially represented by logic 0 and the NACK is initially represented by logic 1.

20. The method of claim 13, further comprising:
logically converting the ACK/NACK information before the individually encoding, if the ACK is initially represented by logic 0 and the NACK is initially represented by logic 1.

21. The method of claim 14, further comprising:
logically converting the received ACK/NACK information, if the ACK is initially represented by logic 0 and the NACK is initially represented by logic 1.

22. The method of claim 15, further comprising:
logically converting the received ACK/NACK information, if the ACK is initially represented by logic 0 and the NACK is initially represented by logic 1.

23. The method of claim 17, further comprising:
logically converting the received ACK/NACK information, if the ACK is initially represented by logic 0 and the NACK is initially represented by logic 1.

24. A system for jointly encoding multiple independent information messages in a communication system, comprising:
an encoder encoding each of the independent information messages to produce respective encoded bits;
a first multiplexer multiplexing each of the independent information messages;
a joint block encoder encoding the multiplexed independent information messages to produce encoded common parity bits shared by all independent information messages; and
a second multiplexer multiplexing the respective encoded bits from each of the independent informant messages and the encoded common parity bits.

25. The system of claim 24, wherein the joint block encoder is further configured to generate a matrix G₀ in dimension
$$( {\sum }_{i = 1}^{L} {K}_{i} ) \times ( N - {\sum }_{i = 1}^{L} {M}_{i} ) ,$$
where L is a total number of independent information messages, N is a total length of a final output codeword, Kᵢ is a length of i-th information message and Mᵢ is an output length for the i-th encoded independent information message.

26. The system of claim 25, wherein an output of the joint block encoder is express by \vec{x} G₀, where \vec{x} is a row vector of length
$${\sum }_{i = 1}^{L} {K}_{i}$$
and is obtained by multiplexing all independent information message bits, and the matrix G₀ is realized using a tentative block code
$$( n = N - {\sum }_{i = 1}^{L} ( {M}_{i} - {K}_{i} ) , k = {\sum }_{i = 1}^{L} {K}_{i} )$$
that has a systematic generator matrix obtained from a lookup table.

27. The system of claim 24, further comprising:
an individual encoder configured to individually encode one or more independent information messages depending on a required error protection of the one or more independent information messages.

28. The system of claim 27, wherein an error protection capability for each of the one or more independent information messages is lower-bounded by dₘᵢₙ(Gᵢ)+dₘᵢₙ(G₀) (i=1 . . . L) for message i, where dₘᵢₙ(Gᵢ) is a minimum hamming distance of code space spanned by a generator matrix Gᵢ, L is the number of the one or more independent information messages, and G₀ is a joint encoder generator matrix.

29. The system of claim 28, wherein the error protection for each of the one or more independent information messages is realized by differentiating dₘᵢₙ(Gᵢ) (i=1 . . . L) for each of the one or more independent information messages i.

30. The system of claim 29, wherein when L=2, the generator matrix G is represented by
$$\begin{matrix}( \begin{matrix}{G}_{1} & 0 \\ 0 & {G}_{2}\end{matrix} \vert & {G}_{0}\end{matrix} ) .$$

31. The system of claim 27, wherein the second multiplexer is further configured to multiplex coded bits from the joint encoding that have been punctured, wherein the number of punctured bits is not large enough to make an effective generator matrix singular for each independent information message.

32. The system of claim 31, further comprising:
an interleaver configured to interleave the multiplexed coded bits such that punctured positions are evenly distributed within a frame.

33. The system of claim 32, wherein the interleaver is further configured to:
shuffle columns of the generator matrix of original code before further multiplexing coded bits from the joint encoding that have been punctured.

34. The system of claim 27, wherein the individually encoder is further configured to:
individual encode N_{ACK} bits of ACK/NACK information, wherein a repetition code, whose generator matrix is
$$( \underbrace{1 … 1}_{all 1 ' s} ) ,$$
shall be used when N_{ACK}=1, and a cyclic simplex code, whose systematic generator matrix for one cycle is
$$( \begin{matrix}1 & 0 & 1 \\ 0 & 1 & 1\end{matrix} ) ,$$
shall be used when N_{ACK}=2.

35. The system of claim 34, wherein ACK is represented by logic 1, and NACK is represented by logic 0, and the ACK/NACK bits follow the CQI bits in a bit ordering of input to the joint encoding, such that if the input bits the joint encoding are defined as a₀, a₁, a₂, a₃, . . . , a_{A-1}, the ACK/NACK and CQI bits are multiplexed before the joint encoding in such a way that
$${a}_{i} = \{ \begin{matrix}CQI bit & 0 \leq i < {N}_{CQI} \\ ACK bit & {N}_{CQI} \leq i < A .\end{matrix}$$

36. The system of claim 27, wherein the output coded bits from the joint block encoder are modulated onto available data symbols, while the output coded bits from the individual encoder are modulated onto either available data symbols or non-data symbols.

37. The system of claim 33, further comprising:
a receiver configured to receive the multiplexed encoded bits without ACK DTX handling to decode a joint ACK/NACK and CQI transmission.

38. The system of claim 33, further comprising:
a receiver configured to receive the multiplexed encoded bits with ACK DTX handling to decode a joint ACK/NACK and CQI transmission.

39. The system of claim 33, further comprising:
a receiver configured to receive the multiplexed encoded bits to decode CQI bits only.

40. The system of claim 36, further comprising:
a receiver configured to receive the multiplexed encoded bits with ACK DTX handling by default to decode joint ACK/NACK and CQI transmission.

41. The system of claim 36, further comprising:
a receiver configured to receive the multiplexed encoded bits to decode CQI bits only.

42. The system of claim 33, further comprising:
a logical converter configured to logically convert the ACK/NACK information before the individually encoding, if the ACK is initially represented by logic 0 and the NACK is initially represented by logic 1.

43. The system of claim 36, further comprising:
a logical converter configured to logically convert the ACK/NACK information before the individually encoding, if the ACK is initially represented by logic 0 and the NACK is initially represented by logic 1.

44. The system of claim 37, further comprising:
a logical converter configured to logically convert the received ACK/NACK information, if the ACK is initially represented by logic 0 and the NACK is initially represented by logic 1.

45. The system of claim 38, further comprising:
a logical converter configured to logically convert the received ACK/NACK information, if the ACK is initially represented by logic 0 and the NACK is initially represented by logic 1.

46. The system of claim 40, further comprising:
a logical converter configured to logically convert the received ACK/NACK information, if the ACK is initially represented by logic 0 and the NACK is initially represented by logic 1.

47. A computer-readable medium storing instructions thereon for performing a method of jointly encoding multiple independent information messages in a communication system, the method comprising:
encoding each of the independent information messages to produce respective encoded bits;
multiplexing each of the independent information messages;
joint encoding the multiplexed independent information messages to produce encoded common parity bits shared by all independent information messages; and
multiplexing the respective encoded bits from each of the independent informant messages and the encoded common parity bits.

48. The computer-readable medium of claim 47, wherein the joint encoding comprises generating a matrix G₀ in dimension
$$( {\sum }_{i = 1}^{L} {K}_{i} ) \times ( N - {\sum }_{i = 1}^{L} {M}_{i} ) ,$$
where L is a total number of independent information messages, N is a total length of a final output codeword, Kᵢ is a length of i-th information message and Mᵢ is an output length for the i-th encoded independent information message.

49. The computer-readable medium of claim 48, wherein an output of the joint encoding is express by \vec{x} G₀, where \vec{x} is a row vector of length
$${\sum }_{i = 1}^{L} {K}_{i}$$
and is obtained by multiplexing all independent information message bits, and the matrix G₀ is realized using a tentative block code
$$( n = N - {\sum }_{i = 1}^{L} ( {M}_{i} - {K}_{i} ) , k = {\sum }_{i = 1}^{L} {K}_{i} )$$
that has a systematic generator matrix obtained from a lookup table.

50. The computer-readable medium of claim 47, further comprising:
individually encoding one or more independent information messages depending on a required error protection of the one or more independent information messages.

51. The computer-readable medium of claim 50, wherein an error protection capability for each of the one or more independent information messages is lower-bounded by dₘᵢₙ(Gᵢ)+dₘᵢₙ(G₀) (i=1 . . . L) for message i, where dₘᵢₙ(Gᵢ) is a minimum hamming distance of code space spanned by a generator matrix Gᵢ, L is the number of the one or more independent information messages, and G₀ is a joint encoder generator matrix.

52. The computer-readable medium of claim 51, wherein the error protection for each of the one or more independent information messages is realized by differentiating dₘᵢₙ(Gᵢ) (i=1 . . . L) for each of the one or more independent information messages i.

53. The computer-readable medium of claim 52, wherein when L=2, the generator matrix G is represented by
$$( \begin{matrix}{G}_{1} & 0 \\ 0 & {G}_{2}\end{matrix} \vert {G}_{0} ) .$$

54. The computer-readable medium of claim 50, wherein the multiplexing the respective encoded bits from all independent channel encoders and the encoded common parity bits comprises further multiplexing coded bits from the joint encoding that have been punctured, wherein the number of punctured bits is not large enough to make an effective generator matrix singular for each independent information message.

55. The computer-readable medium of claim 54, further comprising:
interleaving the multiplexed coded bits such that punctured positions are evenly distributed within a frame.

56. The computer-readable medium of claim 55, wherein the interleaving comprises:
shuffling columns of the generator matrix of original code before further multiplexing coded bits from the joint encoding that have been punctured.

57. The computer-readable medium of claim 50, wherein the individually encoding comprises:
individual encoding N_{ACK} bits of ACK/NACK information, wherein a repetition code, whose generator matrix is
$$( \underbrace{1 … 1}_{all 1 ' s} ) ,$$
shall be used when N_{ACK}=1, and a cyclic simplex code, whose systematic generator matrix for one cycle is
$$( \begin{matrix}1 & 0 & 1 \\ 0 & 1 & 1\end{matrix} ) ,$$
shall be used when N_{ACK}=2.

58. The computer-readable medium of claim 57, wherein ACK is represented by logic 1, and NACK is represented by logic 0, and the ACK/NACK bits follow the CQI bits in a bit ordering of input to the joint encoding, such that if the input bits the joint encoding are defined as a₀, a₁, a₂, a₃, . . . , a_{A-1}, the ACK/NACK and CQI bits are multiplexed before the joint encoding in such a way that
$${a}_{i} = \{ \begin{matrix}CQI bit & 0 \leq i < {N}_{CQI} \\ ACK bit & {N}_{CQI} \leq i < A .\end{matrix}$$

59. The computer-readable medium of claim 50, wherein the output coded bits from the joint encoding are modulated onto available data symbols, while the output coded bits from the individually encoding are modulated onto either available data symbols or non-data symbols.

60. The computer-readable medium of claim 56, further comprising:
receiving the multiplexed encoded bits without ACK DTX handling to decode a joint ACK/NACK and CQI transmission.

61. The computer-readable medium of claim 56, further comprising:
receiving the multiplexed encoded bits with ACK DTX handling to decode a joint ACK/NACK and CQI transmission.

62. The computer-readable medium of claim 56, further comprising:
receiving the multiplexed encoded bits to decode CQI bits only.

63. The computer-readable medium of claim 59, further comprising:
receiving the multiplexed encoded bits with ACK DTX handling by default to decode joint ACK/NACK and CQI transmission.

64. The computer-readable medium of claim 59, further comprising:
receiving the multiplexed encoded bits to decode CQI bits only.

65. The computer-readable medium of claim 56, further comprising:
logically converting the ACK/NACK information before the individually encoding, if the ACK is initially represented by logic 0 and the NACK is initially represented by logic 1.

66. The computer-readable medium of claim 59, further comprising:
logically converting the ACK/NACK information before the individually encoding, if the ACK is initially represented by logic 0 and the NACK is initially represented by logic 1.

67. The computer-readable medium of claim 60, further comprising:
logically converting the received ACK/NACK information, if the ACK is initially represented by logic 0 and the NACK is initially represented by logic 1.

68. The computer-readable medium of claim 61, further comprising:
logically converting the received ACK/NACK information, if the ACK is initially represented by logic 0 and the NACK is initially represented by logic 1.

69. The computer-readable medium of claim 63, further comprising:
logically converting the received ACK/NACK information, if the ACK is initially represented by logic 0 and the NACK is initially represented by logic 1.

70. A system for jointly encoding multiple independent information messages in a communication system, comprising:
means for encoding each of the independent information messages to produce respective encoded bits;
means for multiplexing each of the independent information messages;
means for joint encoding the multiplexed independent information messages to produce encoded common parity bits shared by all independent information messages; and
means for multiplexing the respective encoded bits from each of the independent informant messages and the encoded common parity bits.

71. The system of claim 70, wherein the means for joint encoding comprises means for generating a matrix G₀ in dimension
$$( {\sum }_{i = 1}^{L} {K}_{i} ) \times ( N - {\sum }_{i = 1}^{L} {M}_{i} ) ,$$
where L is a total number of independent information messages, N is a total length of a final output codeword, Kᵢ is a length of i-th information message and Mᵢ is an output length for the i-th encoded independent information message.

72. The system of claim 71, wherein an output of the joint encoding is express by \vec{x}·G₀, where \vec{x} is a row vector of length
$${\sum }_{i = 1}^{L} {K}_{i}$$
and is obtained by multiplexing all independent information message bits, and the matrix G₀ is realized using a tentative block code
$$( n = N - {\sum }_{i = 1}^{L} ( {M}_{i} - {K}_{i} ) , k = {\sum }_{i = 1}^{L} {K}_{i} )$$
that has a systematic generator matrix obtained from a lookup table.

73. The system of claim 72, further comprising:
means for individually encoding one or more independent information messages depending on a required error protection of the one or more independent information messages.

74. The system of claim 73, wherein an error protection capability for each of the one or more independent information messages is lower-bounded by dₘᵢₙ(Gᵢ)+dₘᵢₙ(G₀) (i=1 . . . L) for message i, where dₘᵢₙ(Gᵢ) is a minimum hamming distance of code space spanned by a generator matrix Gᵢ, L is the number of the one or more independent information messages, and G₀ is a joint encoder generator matrix.

75. The system of claim 74, wherein the error protection for each of the one or more independent information messages is realized by differentiating dₘᵢₙ(Gᵢ) (i=1 . . . L) for each of the one or more independent information messages i.

76. The system of claim 75, wherein when L=2, the generator matrix G is represented by
$$( \begin{matrix}{G}_{1} & 0 \\ 0 & {G}_{2}\end{matrix} \vert {G}_{0} ) .$$

77. The system of claim 73, wherein the means for multiplexing the respective encoded bits from all independent channel encoders and the encoded common parity bits comprises further means for multiplexing coded bits from the joint encoding that have been punctured, wherein the number of punctured bits is not large enough to make an effective generator matrix singular for each independent information message.

78. The system of claim 77, further comprising:
means for interleaving the multiplexed coded bits such that punctured positions are evenly distributed within a frame.

79. The system of claim 78, wherein the means for interleaving comprises:
means for shuffling columns of the generator matrix of original code before further multiplexing coded bits from the joint encoding that have been punctured.

80. The system of claim 73, wherein the means for individually encoding comprises:
means for individual encoding N_{ACK} bits of ACK/NACK information, wherein a repetition code, whose generator matrix is
$$( \underbrace{1 … 1}_{all 1 ' s} ) ,$$
shall be used when N_{ACK}=1, and a cyclic simplex code, whose systematic generator matrix for one cycle is
$$( \begin{matrix}1 & 0 & 1 \\ 0 & 1 & 1\end{matrix} ) ,$$
shall be used when N_{ACK}=2.

81. The system of claim 80, wherein ACK is represented by logic 1, and NACK is represented by logic 0, and the ACK/NACK bits follow the CQI bits in a bit ordering of input to the means for joint encoding, such that if the input bits the joint encoding are defined as a₀, a₁, a₂, a₃, . . . , a_{A-1}, the ACK/NACK and CQI bits are multiplexed before the joint encoding in such a way that
$${a}_{i} = \{ \begin{matrix}CQI bit & 0 \leq i < {N}_{CQI} \\ ACK bit & {N}_{CQI} \leq i < A .\end{matrix}$$

82. The system of claim 76, wherein the output coded bits from the means for joint encoding are modulated onto available data symbols, while the output coded bits from the means for individually encoding are modulated onto either available data symbols or non-data symbols.

83. The system of claim 79, further comprising:
means for receiving the multiplexed encoded bits without ACK DTX handling to decode a joint ACK/NACK and CQI transmission.

84. The system of claim 79, further comprising:
means for receiving the multiplexed encoded bits with ACK DTX handling to decode a joint ACK/NACK and CQI transmission.

85. The system of claim 79, further comprising:
means for receiving the multiplexed encoded bits to decode CQI bits only.

86. The system of claim 82, further comprising:
means for receiving the multiplexed encoded bits with ACK DTX handling by default to decode joint ACK/NACK and CQI transmission.

87. The system of claim 82, further comprising:
means for receiving the multiplexed encoded bits to decode CQI bits only.

88. The system of claim 79, further comprising:
means for logically converting the ACK/NACK information before the individually encoding, if the ACK is initially represented by logic 0 and the NACK is initially represented by logic 1.

89. The system of claim 82, further comprising:
means for logically converting the ACK/NACK information before the individually encoding, if the ACK is initially represented by logic 0 and the NACK is initially represented by logic 1.

90. The system of claim 83, further comprising:
means for logically converting the received ACK/NACK information, if the ACK is initially represented by logic 0 and the NACK is initially represented by logic 1.

91. The system of claim 84, further comprising:
means for logically converting the received ACK/NACK information, if the ACK is initially represented by logic 0 and the NACK is initially represented by logic 1.

92. The system of claim 86, further comprising:
means for logically converting the received ACK/NACK information, if the ACK is initially represented by logic 0 and the NACK is initially represented by logic 1.
